(19) United States
(12) Patent Application Publication
(10) Pub. No.: US 2014/0050997 A1
(43) Pub. Date: Feb. 20, 2014

(54) MEMBRANE ELECTRODE ASSEMBLY FOR FUEL CELL OR REDOX FLOW BATTERY

(71) Applicants: Peter Jaime Bouwman, Voorthuizen (NL); Maarten De Bruijne, Heiloo (NL)

(72) Inventors: Peter Jaime Bouwman, Voorthuizen (NL); Maarten De Bruijne, Heiloo (NL)

(73) Assignee: HyEt Holding B.V., Amhem (NL)

(21) Appl. No.: 14/000,713

(22) PCT Filed: Feb. 21, 2012
(86) PCT No.: PCT/NL2012/050098

§ 371 Date: Oct. 22, 2013

(30) Foreign Application Priority Data
Feb. 21, 2011 (NL) 2006266

(51) Int. Cl. H01M 8/04; H01M 8/24

(52) U.S. Cl. CPC H01M 8/04313; H01M 8/241
USPC 429/413; 429/482; 429/465; 429/428; 429/433; 429/444; 429/434; 429/429

(57) ABSTRACT

A membrane electrode assembly includes a reactor constructed from a ion-permeable membrane between a cathode space and an anode space. The membrane includes an extended membrane area which extends outside of the area of the cathode and anode spaces. A carrier layer is attached to and supports the membrane extended area, and the carrier layer is arranged with an integrated circuit adjacent to the fuel cell.

### FIELD OF THE INVENTION

The present invention relates to a membrane electrode assembly. Additionally, the present invention relates to a fuel cell stack comprising a plurality of such membrane electrode assemblies. Also, the present invention relates to a power generating system.

### BACKGROUND

Fuel cell systems provide an electric energy supply based on a controlled reaction between a fuel and an oxidizing agent in the presence of an electrolyte. In a fuel cell, a cathode electrode and an anode electrode are separated from each other by the electrolyte which comprises a membrane. The controlled reaction comprises two partial reactions, one partial reaction (a reduction reaction) taking place at the anode electrode, the other partial reaction (an oxidation reaction) at the cathode electrode. The anode electrode is located in one reactor space containing the fuel (the anode space), and the cathode is located in another reactor space containing the oxidizing agent (the cathode space). The electrolyte or membrane has the function to separate the anode space containing the fuel from the cathode space containing the oxidizing agent and to provide a one-way path for ions to pass between the reactor spaces. The direction of the ions through the membrane depends on the specific partial reactions taking place.

In fuel cells, the anode and cathode electrodes and the membrane are usually arranged in a single structure indicated as Membrane Electrode Assembly (MEA). The specific application of the fuel cell will determine exactly which gasses or chemicals are supplied to the fuel cell as fuel and oxidant, being for example hydrogen and oxygen or air, respectively. However, the described fuel cell concept also works in reverse, where a current is supplied to the fuel cell to electrolyse water or electro-chemically compress hydrogen. The presented invention relates to all applications that utilize the MEA structure.

Fuel cells according to the prior art have demonstrated market feasibility, but may suffer and eventually fail as a result of ‘uncontrolled’ conditions. These conditions include system faults, irregularities in Balance-of-Plant, ‘off-specification’ operating conditions, or plain ‘user’-abuse.

Detrimental events occurring on a local level within a fuel cell, such as fuel starvation, water accumulation, hot-spots, can not be detected properly and may have devastating effects without being detected until it is too late. It is known that non-uniformities may exist in local operating conditions and current density distributions across the active area of the membrane electrode assembly, particularly in case of larger MEAs, low (sub stoichiometric) gas flows and low relatively humidity of supplied gas flows.

Local extremities can lead to premature MEA failure, if no countermeasures are taken.

One trend to overcome these difficulties is to design more robust MEAs using more durable materials so that the MEA would survive any detrimental events, regardless.

Even though significant technical progress has been achieved so far, the most promising solutions appear very costly (e.g. using more platinum) and therefore economic feasibility may be difficult to achieve. Also, while durable materials are applied in fuel cells, the fuel cells remain vulnerable to ‘uncontrolled’ conditions or ‘abuse’ during operation.

It is an object of the present invention to overcome one or more of the disadvantages of the prior art.

### SUMMARY

The objective is achieved by a membrane electrode assembly comprising a fuel cell reactor constructed from a ion-permeable membrane between a cathode space and an anode space, wherein the membrane comprises an extended membrane area which extends outside of the area of the cathode and anode spaces, wherein a carrier layer is attached to and supports the membrane extended area, and the carrier layer is arranged with an integrated circuit adjacent to the fuel cell reactor.

Advantageously, the present invention allows that accurate real-time data on the health status of the MEA in key locations of the active (reactor) area, can be obtained independent whether the fuel cell is operated as single cell or when combined in a stack and also provide a read-out of information upon request when the complete system or parts thereof are switched of or in stand-by mode.

According to an aspect of the invention, there is provided a membrane electrode assembly as described above, wherein the membrane electrode assembly comprises a further carrier layer that is attached to and supports the membrane extended area in such a way that the membrane extended area is sandwiched between portions of the carrier layer and the further carrier layer.

Advantageously, this provides a more robust arrangement of the MEA and saves on the utilization of membrane and thus provides a cost saving.

According to an aspect of the invention, there is provided a membrane electrode assembly as described above, wherein the integrated circuit comprises at least one communications port for electronic signal and data communication with an external device.

According to an aspect of the invention, there is provided a membrane electrode assembly as described above, wherein the integrated circuit is equipped with an upper and a lower connector on the upper and lower surface respectively of the membrane electrode assembly, wherein the upper connector of the integrated circuit on one membrane electrode assembly is configured to couple with the connectors on the top carrier layer of the MEA and a lower connector of the integrated circuit to the bottom carrier layer of the MEA, respectively.

Advantageously, the coupling provides a permanent electrical connection between at least one sensor in a key location on the MEA and the integrated circuit which reads, interprets and communicates the data internally within the fuel cell stack, avoiding the need for any external wirings between the MEAs.

According to an aspect of the invention, there is provided a membrane electrode assembly as described above, wherein the integrated circuit is equipped with an upper and a lower connector on the upper and lower surface respectively of the membrane electrode assembly, wherein the upper connector of the integrated circuit on one membrane electrode assembly is configured to couple the at least one communications port with a lower connector of the integrated circuit of a directly adjacent membrane electrode assembly, and vice versa.

According to an aspect of the invention, there is provided a membrane electrode assembly as described above, wherein the carrier layer comprises upper and lower connectors on an upper and lower surface respectively, that are coupled to the communications port of the integrated circuit, wherein the upper connector on one carrier layer is configured to couple with a lower connector on the carrier layer of a directly adjacent membrane electrode assembly, and vice versa.

According to an aspect of the invention, there is provided a membrane electrode assembly as described above, wherein the integrated circuit is connected over a plurality of conductive lines on one or more surfaces of the carrier layer to one or more sensors that are coupled to regions in the reactor for sensing one or more operational parameters at the respective regions.

Advantageously, the localization of the integrated circuit on the MEA and its coupling to sensors attached to the reactor area allows a local monitoring and processing of sensor data. In this manner, only relevant data require transmission to an external computation device, e.g. a server/computer.

According to an aspect of the invention, there is provided a membrane electrode assembly as described above, wherein the integrated circuit comprises a controllable switching unit to internally reconfigure the wiring of one or more sensors, so as to change its functionality.

Advantageously, this feature allows that the functionality of the sensors and monitoring system can be changed without disassembly and reassembly of the fuel cell (stack).

According to an aspect of the invention, there is provided a membrane electrode assembly as described above, wherein the carrier layer consists of either a paper or non-woven like material or a polymeric layer or film.

According to an aspect of the invention, there is provided a membrane electrode assembly as described above, wherein the carrier layer comprises a gasket layer sealing the gasses within an area of the fuel cell reactor.

According to an aspect of the invention, there is provided a membrane electrode assembly as described above, wherein the carrier layer comprises a material selected from a group comprising poly-imides, polyester poly ethers, poly sulfides, poly acrylates, polyalkanes, and elastomers/rubbers.

According to an aspect of the invention, there is provided a membrane electrode assembly as described above, wherein the one or more sensors are selected from one or more of a group of sensors comprising voltage sensors, current sensors, conductivity sensors, humidity sensors, dielectric sensors, chemical sensors, temperature sensors, pressure sensors, pH sensors and Hall sensors.

According to an aspect of the invention, there is provided a membrane electrode assembly as described above, wherein the sensors are configured to measure an input level of fuel into the fuel cell reactor, an input level of oxygen into the fuel cell reactor, an output level of fuel from the fuel cell reactor, and an output level of oxygen from the fuel cell reactor.

According to an aspect of the invention, there is provided a membrane electrode assembly as described above, wherein a sensor is coupled to a region of the fuel cell reactor for measuring an operational parameter selected from a group of sensors comprising voltage, generated current, concentration of catalyst-poisoning agents, electrical conductivity, ionic conductivity, humidity, temperature, and operating pressure.

According to an aspect of the invention, there is provided a membrane electrode assembly as described above, wherein the integrated circuit is configured to monitor a combination of two sensors selected from the group of sensors in a differential mode between said two sensors.

According to an aspect of the invention, there is provided a membrane electrode assembly as described above, wherein the two sensors are arranged on a same side of the membrane.

According to an aspect of the invention, there is provided a membrane electrode assembly as described above, wherein one of the two sensors is arranged on one side of the membrane and the other of the two sensors is arranged on an opposite side of the membrane.

The present invention further relates to a fuel cell stack comprising a stack of a plurality of membrane electrode assemblies as described above, and a fuel cell stack communications bus, wherein each integrated circuit has a communications port coupled to the fuel cell stack communication bus.

According to an aspect of the invention, there is provided a fuel cell stack as described above, comprising a stack of a plurality of membrane electrode assemblies as described above, and a fuel cell stack communications bus, wherein each integrated circuit is configured for carrying out: -detecting adjacent integrated circuits, -deducing a total size of the stack, -subsequently recognizing its relative location in the fuel cell stack and -assigning its bus address in relation to the location in the fuel cell stack.

Advantageously, the invention provides that the integrated circuits are self arranging in the sense that the integrated circuit becomes aware of the position of the MEA in the fuel cell stack. As a result, the integrated circuit can be arranged to monitor the MEA's reactor area in dependence of the position in the fuel cell stack. This feature allows an “intelligent” control of each individual fuel cell in the stack.

The present invention also relates to a power generating system comprising a fuel cell stack as described above and a control system, wherein the control system is configured for control of operation of the fuel cell stack and the control system is equipped with a communications port coupled to the fuel cell stack communications bus.

According to an aspect of the invention, there is provided a power generating system as described above, wherein the control system is configured for active ‘reflex’ control so as to prevent damage to one or more membrane electrode assemblies, when one or more of the sensors detect detrimental operation conditions as defined by measured values from one or more of the sensors.

According to an aspect of the invention, there is provided a power generating system as described above, wherein the control system is configured for active ‘reflex’ control so as to maintain specific operating conditions in the cell, or on either electrode, being temperature, humidity or concentration or pressure of gasses on the anode or cathode of the system, when one or more of the sensors detect deviating operation conditions as defined by measured values from one or more of the sensors.

According to an aspect of the invention, there is provided a power generating system as described above, wherein the integrated circuit of the one or more membrane electrode assemblies is configured to transmit along one or more of the sensors coupled to the respective integrated circuit, small currents towards or from the active area of the respective fuel cell associated with said integrated circuit in order to offset its operation.

According to an aspect of the invention, there is provided a power generating system as described above, wherein the integrated circuit of the one or more membrane electrode assemblies is configured to pass along one or more of the conductive pathways on the border of the MEA a current of significant amount to introduce heat into the system and thus function as means for thermal control of the stack during operation or intermediate characterization and during the start-up or shut-down sequence of the system. In this way the temperature can be conveniently controlled.

Other features, applications and advantages of the present invention will be apparent from the following description of embodiments of the invention.

### BRIEF DESCRIPTION OF DRAWINGS

The invention will be explained in more detail below with reference to a few drawings in which illustrative embodiments thereof are shown. They are intended exclusively for illustrative purposes and not to restrict the inventive concept, which is defined by the claims.

In the following figures, the same reference numerals refer to similar or identical components in each of the figures.

FIG. 1a shows a top view of a membrane electrode assembly according to an embodiment of the invention;

FIG. 1b shows a cross-section of the membrane electrode assembly of FIG. 1a along line b-b;

FIG. 1c shows a cross-section of the membrane electrode assembly of FIG. 1a in an alternative configuration;

FIG. 2 shows a schematic circuit in accordance with a membrane electrode assembly of the present invention;

FIG. 3 shows a schematic arrangement of a plurality of membrane electrode assemblies according to the invention, and

FIG. 4 shows a diagram of a fuel cell stack connected to a monitoring device/controller.

### DETAILED DESCRIPTION

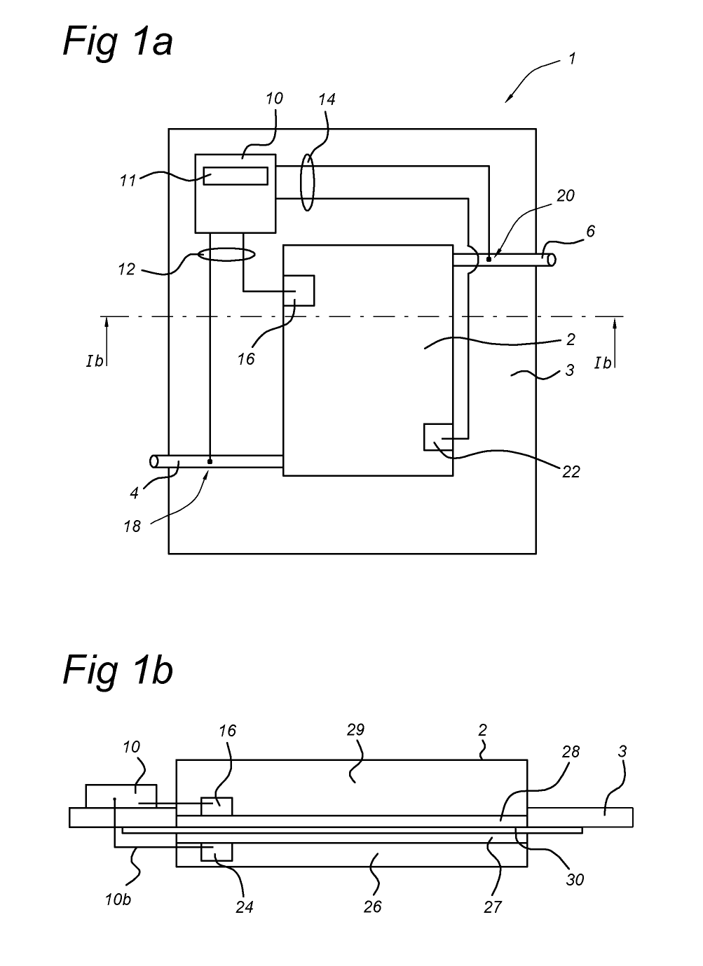

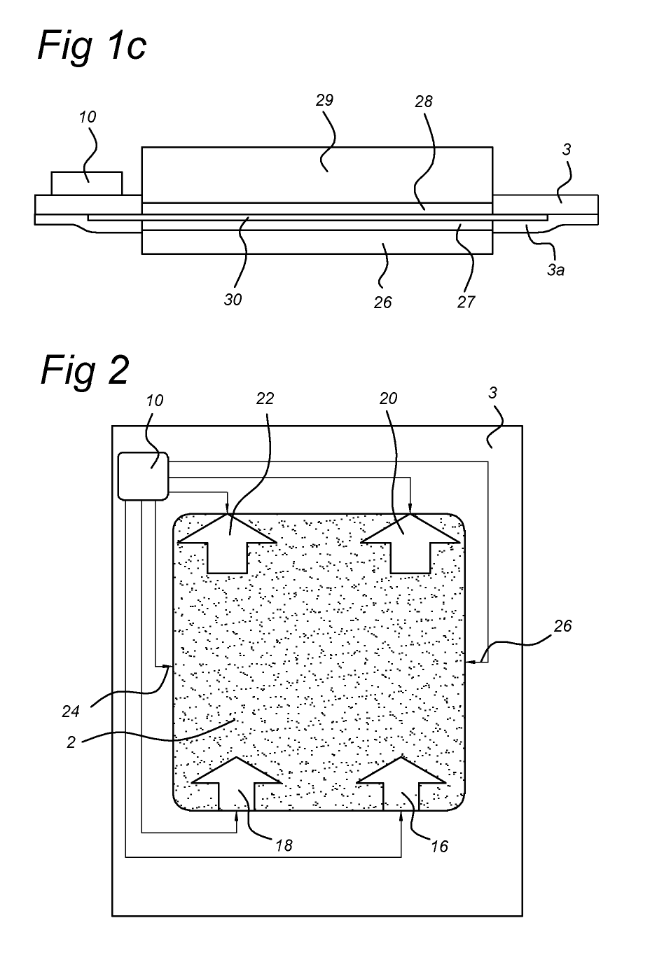

In FIG. 1a, a top view of a membrane electrode assembly (MEA) 1 according to an embodiment of the invention is shown.

The membrane electrode assembly 1 comprises a reactor 2 which is constructed from a membrane (not shown) which functions as ion-permeable interface between the cathode space (not shown) and the anode space (not shown).

The membrane comprises an extended membrane area which extends outside of the active area of the fuel cell reactor 2.

The membrane extended area is attached or laminated with a carrier layer 3, which supports the membrane extended area. The carrier layer 3 comprises at a region adjacent to the membrane electrode assembly 2 an integrated circuit 10.

The integrated circuit 10 is connected over a plurality of conductive lines 12, 14 on the surface of the carrier layer 3 to a plurality of sensors 16, 18, 20, 22 that are coupled to regions of the fuel cell reactor area 2 within the membrane electrode assembly for sensing one or more operational parameters at the respective regions, as will be described in more detail below.

By arranging multiple sensors on a single reactor 2, it is achieved that more operational parameters or a spatial resolution of an operational parameter can be monitored.

The integrated circuit 10 is linked to a communication bus (not shown) to an external controller or processing unit and to other external resources such as a power supply. The external controller is typically configured for controlling the operation of the fuel cell reactor 2.

The communication bus will be described in more detail below with reference to FIG. 4.

The fuel cell hardware comprises a Gas Diffusion Layer (GDL) where the gaseous reactants enter either the anode space or cathode space of the reactor area from the respective gas feed. Additionally, one or more sensors may be placed near or within the GDL. As will be appreciated by the skilled in the art, each gas feed may comprise a flowfield plate (a plate comprising a groove pattern) to distribute a gasflow over the area of the GDL. The flowfield plate determines where the fresh reactants see the back of the GDL first and how these are distributed over the remaining surface area of the GDL. Usually, gasses enter and exit at the edge of the reactor through a spacing underneath an enclosing gasket

In FIG. 1a, schematically inlets 4 and outlets 6 are shown for agents and reactants in the cathode and anode spaces, respectively.

The conductive lines 12, 14 are arranged on at least the top surface of the carrier layer 3, but may also be arranged on the underside surface of the carrier layer 3. In an alternative configuration the carrier layer 3 consists of a multi-layer structure of a stack of two or more layers where the conductive lines 12, 14 are captured between at least two layers of the stack so as to provide better protection.

To withstand the operating conditions in the reactor/membrane electrode assembly and to be compatible with the membrane material, in an embodiment, the carrier layer 3 consists of a paper or non-woven type material or a polymeric material such as poly-imide (e.g. Kapton) or polyesters (e.g. PET, PEN) or poly ethers (e.g. PEI, PEEK) or poly sulfides (e.g. PPS) or polyacrylates (e.g. PAN) or polyalkane (e.g. PE, PP). The material of the carrier layer is to be chemically resistant and dimensionally stable throughout the manufacturing and operation conditions.

The plurality of conductive lines 12, 14 may be formed by metallic, carbon-based, or conductive polymer lines applied on the surface(s) of the carrier layer 3 using a process such as printing, sputtering, (electro-(less))-deposition, or etching structures from a pre-deposited film.

FIG. 1b shows a cross-section of the membrane electrode assembly 1 of FIG. 1a along line b-b.

In FIG. 1b entities with the same reference number as shown in the preceding figures refer to corresponding entities.

In the cross-section the reactor 2 is shown schematically.

The reactor 2 comprises the membrane 30, the first electrode 27 and the second electrode 28.

The first electrode 27 is supported on one side of the membrane 30, and is enclosed in a first electrode space 26 that during use contains agents and reactants that are components in the partial reaction taking place at the first electrode 27.

Likewise, the second electrode 28 is supported on the opposite side of the membrane 30, and is enclosed in a second electrode space 29 that during use contains agents and reactants that are components in the other partial reaction taking place at the second electrode 28.

The membrane extended area outside of the areas of the first and second electrode spaces is attached to the carrier layer 3. The carrier layer 3 can extend further out into the border region than the membrane 30 in an attempt to save on membrane material cost and secondly to allow for direct contact between both carrier layer film on the same MEA.

As shown in FIG. 1b, the attachment between the carrier layer 3 to the membrane 30 can be achieved using a process of hot melting (lamination) or cross-linking or mechanical pressure or with the addition of tackifiers, pressure sensitive adhesive (PSA) or glues.

On a portion of the carrier layer 3, the integrated circuit 10 is arranged. A connection 10A of the integrated circuit is shown to a sensor 16 positioned against the membrane 30 and within in the second electrode space 28. Further, a connection 10B of the integrated circuit 10 to a sensor 24 positioned in the first electrode space is shown.

In an alternative configuration as shown in FIG. 1c the membrane 30 is enclosed on one side by a carrier layer 3 and on the opposite side by a further carrier layer 3a (“sandwich construction”).

The invention advantageously achieves by using a carrier layer with a layout of conductor lines that a precise disposal of one or more sensors on/in the membrane electrode assembly can be facilitated. Also, the use of conductor lines on the carrier layer reduces the amount of (external) wiring for these sensors.

Further, the application of the integrated circuit 10 directly adjacent to the reactor 2 allows that the operation of the reactor can be monitored locally. The integrated circuit can be configured to monitor signals from the reactor 2 as measured by the sensors. The signal readings from combinations of (opposing) sensors can be processed (in tandem) on a local level to construct a comprehensive picture of the health status of the MEA, thus avoiding the transfer of large amounts of ‘meaningless’ (i.e., yet unprocessed) data onto the system communication bus.

The monitoring may involve a comparison with predetermined values, or a predetermined trend of data or another relationship of the data. Such predetermined values may be stored in a memory region of the integrated circuit 10. These predetermined values will differentiate between ‘normal’ and ‘adnormal’ operation of the MEA and may vary according to the chosen (system) operation mode and target application and the design of the membrane electrode assembly with its inherent performance characteristics.

In an embodiment, the integrated circuit 10 may be programmable in such a way that the predetermined values can be adapted to specific fuel cell applications.

Based on the monitoring or comparison, the integrated circuit may handle the data locally or provide a signal to an external system (not shown) in case of a malfunction or non-optimal operation. This will be described in more detail below with reference to FIG. 4.

The membrane electrode assembly according to the present invention advantageously allows that per individual membrane electrode assembly real-time data on the “health status” of the membrane electrode assembly can be obtained at key locations of the reactor 2. Due to the locality of the measurements on a specific membrane electrode assembly, instabilities in the reactor can be attributed to a position on that membrane electrode assembly. In particular, during transient conditions such as start-up and shutdown, this feature may provide valuable diagnostic data.

FIG. 2 shows a schematic circuit in accordance with an embodiment of the membrane electrode assembly of the present invention.

The integrated circuit 10 arranged on the carrier layer 3 of the membrane electrode assembly 1 can be coupled with various sensors 16, 18, 20, 22, 24 and 26 to monitor operation conditions of the membrane electrode assembly.

Each of the sensors may be selected from one or more of a group comprising local monitors for example based on a sensor selected from a group comprising potential sensors, current sensors, conductivity sensors, humidity sensors, chemical sensors, temperature sensors, pressure sensors, pH sensors and Hall sensors (for measuring local current density). The skilled person will appreciate that other types of sensors may be used as well. The location and position of the sensor is such that the sensor experiences the local environment in the reactor area 2, and can be adjacent, but not necessarily connected to the electrode or the membrane. Note that, in contrast, prior art ‘voltage monitoring boards’ in fuel cell systems tend to read the average voltage of the whole electrode.

In the embodiment shown in FIG. 2, the sensors are configured to measure, for example, input level of fuel (comprising hydrogen) into the fuel cell at sensor 16, input level of oxygen at sensor 18, output level of fuel from the fuel cell at sensor 20, and output of oxygen at sensor 22. A number of additional sensors 24, 26 may be coupled to the fuel cell 2 for measuring these fuel and oxygen levels halfway the corresponding reactor surface areas. These sensor may be multifunctional and also measure additional operational parameters, such as generated current, temperature, operating pressure, etc.

In an embodiment, the sensors can be reconfigured to measure multiple operation parameters by addressing the sensors in different manners: in this embodiment the integrated circuit 10 has ‘switching’ capability (a controllable switching unit) embedded in its hardware that can upon demand internally re-wire the sensor connections to its available functions in order to, for example, consecutively pass a current, apply a potential, read a voltage. The controllable switching unit can be triggered automatically through the clock signal or when called for by the processing unit of the integrated circuit. Its application here allows to extract more information from a relatively simple sensor configuration.

In addition to its monitoring function, the integrated circuit 10 may be configured (or programmed to carry out a method) for active ‘reflex’ control to prevent damage to the MEA. For example, the integrated circuit could pass small currents towards or from the active area of the fuel cell in order to offset the (Open Circuit Voltage) operation conditions in specific circumstances as defined by measured values from one or more of the sensors that are regarded detrimental in all cases. Hence, preventive measures have already been applied whilst an external system is notified and provided the option for alternative or additional countermeasures. Fast and appropriate responses present the capability to increase lifetime of the MEA itself. Active ‘reflex’ control can be used to maintain specific operating conditions in the cell 2, or on either electrode, being temperature, humidity or concentration or pressure of gasses on the anode or cathode of the system, when one or more of the sensors 16, 18, 20, 22, 24 or 26 detect deviating operation conditions as defined by measured values from one or more of the sensors.

It is noted that the position of the sensors, inputs and outputs and the integrated circuit 10 are only shown here schematically. In some embodiments, the actual positions of the sensors, inputs and outputs and the integrated circuit may be different.

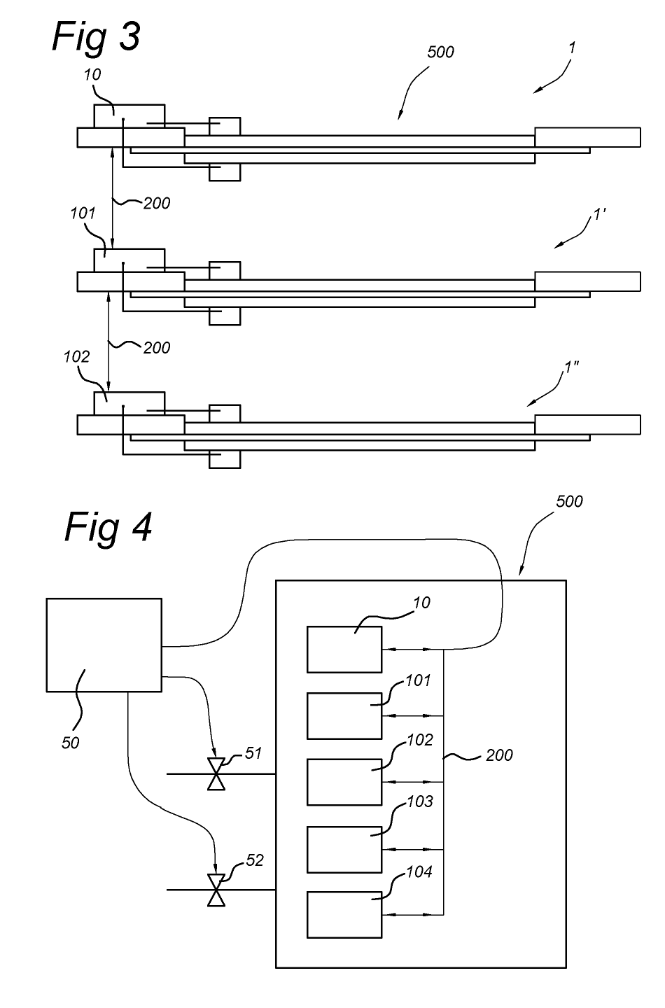

FIG. 3 shows a schematic arrangement of a fuel cell stack having a plurality of membrane electrode assemblies 1, 1′, 1″ according to the invention.

In a fuel cell stack, the plurality of membrane electrode assemblies 1, 1′, 1″ is stacked on each other, in such a way that the integrated circuit 10 on each membrane electrode assembly 1 is connected to the integrated circuits on the other membrane electrode assemblies through a fuel cell stack communication bus 200, as depicted by vertical lines 200.

In an embodiment, each integrated circuit is equipped with an upper and a lower connector on the upper and lower surface respectively of the membrane electrode assembly, wherein the upper connector of the integrated circuit on one membrane electrode assembly is configured to couple with a lower connector of the integrated circuit of a directly adjacent membrane electrode assembly above in the fuel cell stack. The lower connector of the integrated circuit on the one membrane electrode assembly is configured to couple with an upper connector of the integrated circuit of a directly adjacent membrane electrode assembly below in the fuel cell stack. In this manner a direct coupling between integrated circuits of adjacent fuel cells in the fuel cell stack can be achieved.

In an alternative embodiment, the carrier layer 3 comprises upper and lower connectors coupled to a communication port of the integrated circuit on the carrier layer, wherein the upper connector on one carrier layer is configured to couple with a lower connector on the carrier layer of a directly adjacent membrane electrode assembly above in the fuel cell stack. The lower connector on the one carrier layer is configured to couple with a upper connector on the carrier layer of a directly adjacent membrane electrode assembly below in the fuel cell stack.

Advantageously, the coupling of fuel cells and their respective integrated circuits in a fuel cell stack removes the need for external wiring of individual fuel cells outside of the fuel cell stack.

The skilled person will appreciate that in other aspects the stacking of the fuel cells will be similar as in prior art fuel cell stacks. Delivery and removal of agents and reactants to/from the individual fuel cells, output of electrical power, etc., will be similar as in the prior art.

FIG. 4 shows a schematic diagram of the coupling of membrane electrode assembly integrated circuits to a monitoring device/controller.

A fuel cell stack 500 comprises a plurality of fuel cells that each comprise a membrane electrode assembly 1 arranged with an integrated circuit. Each integrated circuit 10, 101, 102, 103, 104 has a communications port coupled to the fuel cell stack communication bus 200. Further, the fuel cell stack communications bus 200 is coupled to a communications port of an external controller 50.

In an embodiment, the fuel stack communications bus 200 is embodied by the link of the integrated circuit on each membrane electrode assembly to the integrated circuit on the directly adjacent membrane electrode assembly in the fuel cell stack, either by connection of interfaces on each of the coupling integrated circuits or by connection of connectors on each of the respective carrier layers that hold the coupling integrated circuits.

The fuel cell stack communications bus 200 may be of any conceivable type, for example a CAN (Controller Area Network) bus. The external controller 50 may be of any conceivable type capable of monitoring and/or controlling a fuel cell stack.

In an embodiment, the external controller 50 may comprise an interface 51, 52 for control of the inputs of the agents and reactants to either the cathode electrode space or the anode electrode space of a selection of one or more individual reactors in the fuel cell stack.

As described above, the integrated circuit 10 of each membrane electrode assembly is arranged to monitor signals from the membrane electrode assembly as measured by the sensors. The integrated circuit 10 is further arranged to handle data on the measured signals locally, and only to provide a fuel cell operation related message signal to the external system 50 in case of an operational event which requires an external control action, such as a malfunction or non-optimal operation.

Advantageously, by local processing of data of the fuel cell and only communicating essential operational events, the invention provides a reduction of data signals to be handled by the communications bus and the external controller. As a result, real time monitoring and/or control of the fuel cell stack by the external controller becomes more efficient.

Also, the integrated circuit 10 of the one or more membrane electrode assemblies 1, 1′, 1″ can be configured to pass along one or more of the conductive pathways on the border of the MEA a relatively large current for supplying heat into the system in order to thermally control the stack during operation or intermediate characterization and during the start-up or shut-down sequence of the system.

The present invention also relates to a power generating system comprising a fuel cell stack with a fuel stack communications bus coupled to the integrated circuit of each membrane electrode assembly in the fuel cell stack as described above, and a control system, wherein the control system is configured for control of operation of the fuel cell stack and the control system is equipped with a communications port coupled to the fuel cell stack communications bus.

The skilled person will appreciate that the present invention relates to fuel cell reactor arrangements as well as redox flow battery arrangements that are equipped with the membrane electrode assembly of the present invention. The design and construction of the membrane electrode assembly as described above can be adopted also in redox flow battery arrangements.

The invention has been described with reference to the preferred embodiment. Obvious modifications and alterations will occur to others upon reading and understanding the preceding detailed description. It is intended that the invention be construed as including all such modifications and alterations insofar as they come within the scope of the appended claims.

1. A membrane electrode assembly (1) comprising a fuel cell reactor (2) constructed from a ion-permeable membrane (30) between a cathode space (26, 27) and an anode space (29, 28), wherein the membrane comprises an extended membrane area which extends outside of the area of the cathode and anode spaces,
wherein a carrier layer (3) is attached to and supports the membrane extended area, and
the carrier layer (3) is arranged with an integrated circuit (10) adjacent to the fuel cell reactor (2).

2. The membrane electrode assembly according to claim 1, wherein the membrane electrode assembly comprises a further carrier layer that is attached to and supports the membrane extended area in such a way that the membrane extended area is sandwiched between portions of the carrier layer and the further carrier layer.

3. The membrane electrode assembly according to claim 1, wherein the integrated circuit (10) comprises at least one communications port for electronic signal and data communication with an external device.

4. The membrane electrode assembly according to claim 3, wherein the integrated circuit (10) is equipped with an upper and a lower connector on the upper and lower surface respectively of the membrane electrode assembly, wherein the upper connector of the integrated circuit on one membrane electrode assembly is configured to couple with the connectors on the top carrier layer of the MEA and a lower connector of the integrated circuit to the bottom carrier layer of the MEA, respectively.

5. The membrane electrode assembly according to claim 3, wherein the integrated circuit (10) is equipped with an upper and a lower connector on the upper and lower surface respectively of the membrane electrode assembly, wherein the upper connector of the integrated circuit on one membrane electrode assembly is configured to couple the at least one communications port with a lower connector of the integrated circuit of a directly adjacent membrane electrode assembly, and vice versa.

6. The membrane electrode assembly according to claim 3, wherein the carrier layer (3) comprises upper and lower connectors on an upper and lower surface respectively, that are coupled to the communications port of the integrated circuit, wherein the upper connector on one carrier layer is configured to couple with a lower connector on the carrier layer of a directly adjacent membrane electrode assembly, and vice versa.

7. The membrane electrode assembly according to claim 1, wherein the integrated circuit (10) is connected over a plurality of conductive lines (12, 14) on one or more surfaces of the carrier layer to one or more sensors (16, 18, 20, 22) that are coupled to regions in the reactor (2) for sensing one or more operational parameters at the respective regions.

8. The membrane electrode assembly according to claim 1, wherein the integrated circuit (10) comprises a controllable switching unit to internally reconfigure the wiring of one or more sensors, so as to change its functionality.

9. The membrane electrode assembly according to claim 1, wherein the carrier layer (3) consists of either a paper or non-woven like material or a polymeric layer.

10. The membrane electrode assembly according to claim 1, wherein the carrier layer comprises a gasket layer sealing the gasses within the reactor area.

11. The membrane electrode assembly according to claim 1, wherein the carrier layer comprises a material selected for a group comprising polyimides, polyester poly ethers, poly sulfides, poly acrylates, poly alkanes, and elastomers/rubbers.

12. The membrane electrode assembly according to claim 7, wherein the one or more sensors are selected from one or more of a group comprising voltage sensors, current sensors, conductivity sensors, humidity sensors, dielectric sensors, chemical sensors, temperature sensors, pressure sensors, pH sensors and Hall sensors.

13. The membrane electrode assembly according to claim 7, wherein the sensors are configured to measure an input level of fuel into the reactor (2), an input level of oxygen into the reactor, an output level of fuel from the reactor (2), and an output level of oxygen from the reactor.

14. The membrane electrode assembly according to claim 12, wherein a sensor is coupled to a region of the reactor (2) for measuring an operational parameter selected from a group comprising voltage, generated current, concentration of catalyst-poisoning agents, electrical conductivity, ionic conductivity, humidity, temperature, and operating pressure.

15. The membrane electrode assembly according to claim 12, wherein the integrated circuit is configured to monitor a combination of two sensors selected from the plurality of sensors in a differential mode between said at least two sensors.

16. The membrane electrode assembly according to claim 15, wherein the at least two sensors are arranged on a same side of the membrane.

17. The membrane electrode assembly according to claim 15, wherein one of the two sensors is arranged on one side of the membrane and the other of the two sensors is arranged on an opposite side of the membrane.

18. A fuel cell stack (500) comprising a stack of a plurality of membrane electrode assemblies according to claim 1, and a fuel cell stack communications bus, wherein each integrated circuit (10, 101, 102, 103, 104) has a communications port coupled to the fuel cell stack communication bus (200).

19. A fuel cell stack (500) comprising a stack of a plurality of membrane electrode assemblies according to claim 18, and a fuel cell stack communications bus, wherein each integrated circuit (10, 101, 102, 103, 104) is configured for carrying out:
detecting adjacent integrated circuits,
deducing a total size of the stack,
subsequently recognizing its relative location in the fuel cell stack and
assigning its bus address in relation to the location in the fuel cell stack.

20. A power generating system comprising a fuel cell stack according to claim 18, and a control system, wherein the control system is configured for control of operation of the fuel cell stack and the control system is equipped with a communications port coupled to the fuel cell stack communications bus.

21. The power generating system according to claim 20, wherein the control system is configured for active ‘reflex’ control so as to prevent damage to one or more membrane electrode assemblies, when one or more of the sensors detect detrimental operation conditions as defined by measured values from one or more of the sensors.

22. The power generating system according to claim 20, wherein the control system is configured for active ‘reflex’ control so as to maintain specific operating conditions in the cell, or on either electrode, being temperature, humidity or concentration or pressure of gasses on the anode or cathode of the system, when one or more of the sensors detect deviating operation conditions as defined by measured values from one or more of the sensors.

23. The power generating system according to claim 21, wherein the integrated circuit of the one or more membrane electrode assemblies is configured to pass along one or more of the sensors coupled to the respective integrated circuit, small currents towards or from the active area of the respective fuel cell in order to offset the operation.

24. The power generating system according to claim 20, wherein the integrated circuit of the one or more membrane electrode assemblies is configured to pass along one or more of the conductive pathways on the border of the MEA a current of significant amount to introduce heat into the system and thus function as means for thermal control of the stack during operation or intermediate characterization and during the start-up or shut-down sequence of the system.
